(19) United States
(12) Patent Application Publication
(10) Pub. No.: US 2004/0132524 A1
(43) Pub. Date: Jul. 8, 2004

(54) Bonus method for gaming device

(76) Inventors: Christopher M. Ramstad, Santa Rosa, CA (US); Adam A. Weiss, Santa Rosa, CA (US)

Correspondence Address: A.C. Designs, 3048 Mule Deer Ln, Santa Rosa, CA, 95047, US

(21) Appl. No.: 10/687,150

(22) Filed: Oct. 16, 2003

Related U.S. Application Data
(60) Provisional application No. 60/419,736, filed on Oct. 18, 2002.

(51) Int. Cl. A63F 13/00

(52) U.S. Cl. 463/16

(57) ABSTRACT

A player is dealt a hand of cards, and bonus items. The bonus items are unique, each one corresponding to a unique card or unique set of cards in the deck from which the player's hand was drawn. The player may discard cards and receive new cards, resulting in a final hand, as in a normal poker game. In addition to the normal poker hand evaluation, this final hand is evaluated for any bonus winnings based on the bonus items. Additional winnings are awarded depending upon the number of bonus items that match the player's final hand. In another variation, multiple players compete against each other in an attempt to be the first player to match or “qualify” all of a common set of bonus items. As the bonus items are qualified, winnings are paid into a common bank. The first player to qualify all bonus items is awarded the contents of the bank.

### CROSS REFERENCE TO RELATED APPLICATIONS

U.S. Pat. No. 6,599,193 Jul. 29, 2003 Baerlocher et al.

U.S. Pat. No. 6,457,714 Oct. 1, 2002 Feola

U.S. Pat. No. 6,419,578 Jul. 16, 2002 Moody

U.S. Pat. No. 5,816,916 Oct. 6, 1998 Moody

### STATEMENT REGARDING FEDERALLY SPONSERED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

This invention relates primarily to electronic video poker games, and more particularly to electronic video poker games that are single player games in which a player plays one or more poker hands against a pay table, and not against a dealer's hand. The player attempts to achieve final card combinations that are based on poker hand rankings. Typically an initial hand is dealt to the player and the player is allowed to discard unwanted cards and to replace the unwanted cards with replacement cards. The final poker hand is compared to a pay table to determine winning and losing hands. During the play of the game, the player may achieve bonus combinations based on the player's final hand and a set of bonus items that are displayed to the player that allow the player to win higher payouts.

The present invention has many variations with the common thread being that the player is dealt bonus items, which are compared with the player's final hand to determine bonus winnings. In one variation, the player tries to match cards in the final hand to bonus items. In another variation, multiple players compete to win the contents of a bank by being the first to match a common set of bonus items.

### BRIEF SUMMARY OF THE INVENTION

One version is a single player version. Typically a player is dealt a hand of cards and a set of bonus items. The player attempts to achieve final card combinations that are based on poker hand rankings and attempts to match bonus items as well. Typically an initial hand is dealt to the player and the player is allowed to discard unwanted cards and to replace the unwanted cards with replacement cards. The final poker hand is compared to a pay table to determine winning and losing hands. The final hand is also evaluated based on the bonus items and the bonus pay table to determine bonus winnings.

Another version is a multiple player game. The concept of a bonus cycle is introduced to describe the play cycle for multiple players. A bonus cycle begins when the first wager is made by any player and no bonus cycle is currently active. During a bonus cycle, all players will be given the same set of bonus items. Each player's final hand is compared to the bonus items, and winnings are determined. Some percentage of the winnings is paid into a central bank that all players contribute to. As part of the comparison process, some or all of the bonus items are qualified. The first player to qualify all of the bonus items in any bonus cycle will win the contents of the bank and end the bonus cycle. At this time, a new bonus cycle will begin with the next wager.

### BRIEF DESCRIPTION OF THE SEVERAL VIEWS OF THE DRAWINGS

FIG. 1 is a generic screen display showing all of the elements of the game.

FIG. 2 shows an example pay table for the poker game and example bonus pay table.

FIG. 3 shows the screen display of the first hand of a non-bonus winning hand for Version #1.

FIG. 4 shows the screen display after the player has selected which cards to hold in a non-bonus winning hand for Version #1.

FIG. 5 shows the screen display of the final hand of a non-bonus winning hand for Version #1.

FIG. 6 shows the screen display of the first hand of a bonus winning hand for Version #1.

FIG. 7 shows the screen display after the player has selected which cards to hold in a bonus winning hand for Version #1.

FIG. 8 shows the screen display of the final hand of a bonus winning hand for Version #1.

FIG. 9 shows the screen display of the first hand of a winning hand plus a bonus for Version #1.

FIG. 10 shows the screen display after the player has selected which cards to hold in a winning hand plus a bonus for Version #1.

FIG. 11 shows the screen display of the final hand of a winning hand plus a bonus for Version #1.

FIG. 12 shows the screen display of the start of a bonus cycle in Version #2.

FIG. 13 shows the screen display of the initial hand where two the player was dealt and held two cards that match cards in the bonus hand.

FIG. 14 shows the screen display of the final hand where the player has qualified two bonus items.

FIG. 15 shows the screen display of the initial hand where the player was dealt a card theat matched a third bonus item.

FIG. 16 shows the screen display of the final hand where a third bonus item is qualified by the player's hand.

FIG. 17 shows the screen display of the final hand where a fourth bonus item is qualified by the player's hand.

FIG. 18 shows the screen display where the fifth and final card is qualified

FIG. 19 shows the start of the next bonus cycle.

### DETAILED DESCRIPTION OF THE INVENTION

There are two main preferred embodiments that will be enumerated here. The first, called Version #1, is the implementation based on claim 5 from the claims section of this document. The second, called Version #2, is based on claim 7 from the claims section.

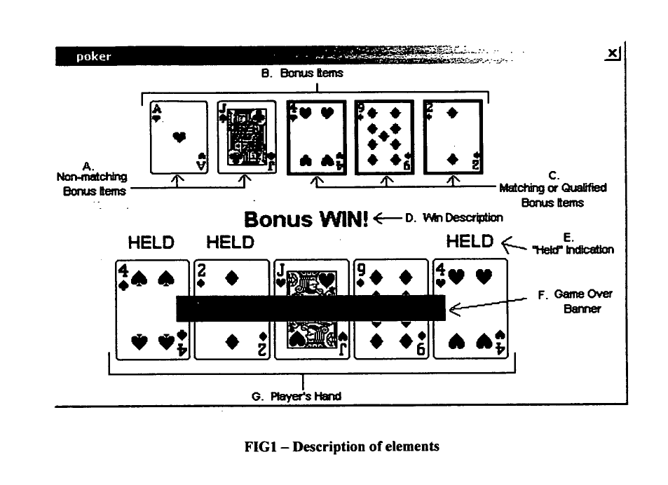

FIG. 1 describes the basic elements displayed to the player on the screen for both Version #1 and Version #2. Refer to FIG. 1 for the following descriptions: FIG. 1—A is an example of a non-matching bonus item. In this example, it is a card in the bonus hand that does not match any cards in the player's final hand.

FIG. 1—B is the bonus items represented as a secondary hand of cards.

FIG. 1—C is an example of matching bonus items. These are cards in the bonus hand that match cards in the player's final hand.

FIG. 1—D is a visual indication of the results of both the standard poker final hand evaluation and the matching bonus evaluation.

FIG. 1—E is a visual indication to the player of which cards from the initial hand have been carried over to the final hand.

FIG. 1—F is a visual indication to the player that the current game has completed.

FIG. 1—G is the player's hand of cards.

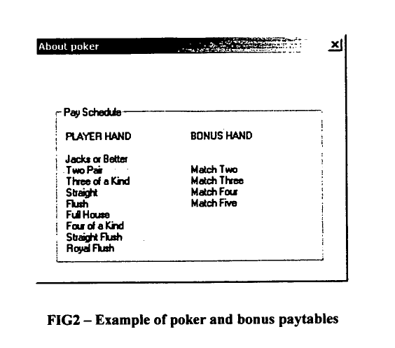

FIG. 2 is an example pay table used for the examples in this document. However, it is important to note that specific pay amounts and combinations have no impact on the claims made by this invention and the following schedule is only an example.

In Version #1 the player is dealt an initial hand of cards and a hand of bonus cards. The player can select cards from the initial hand to hold and discard the remaining cards. The player is then dealt replacement cards to result in a final hand. The final hand is evaluated using the standard poker pay table to determine if the hand is a winning combination or not. The final hand is also compared with the bonus hand, and depending on the number of cards in the final hand that match cards in the bonus hand, a bonus may also be awarded.

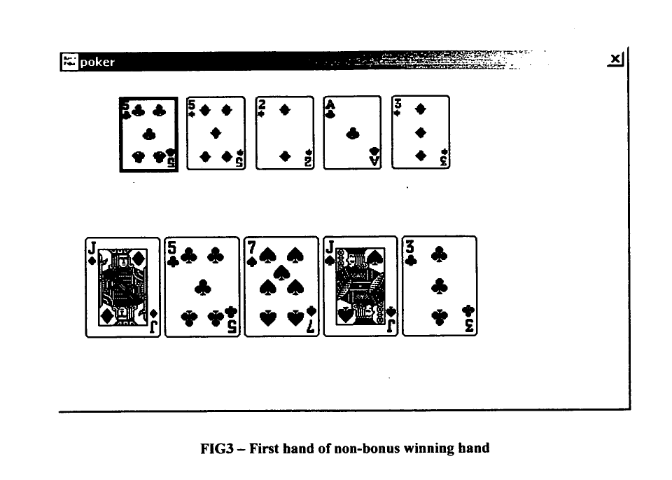

The following example, including FIG. 3 through FIG. 5, depicts the case where the final hand evaluation results in a winning combination from the standard pay table, but no bonus award.

FIG. 3 shows the initial hand and bonus hand. At this point the player decides which, if any, cards to hold and which cards to discard.

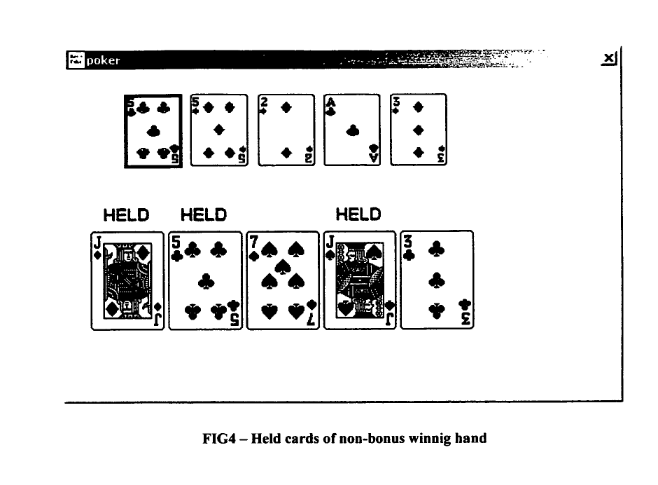

The pay tables as described in FIG. 2 show that a pair of jacks is a winning hand. It also shows that matching at least two bonus cards will result in a bonus award. In FIG. 4, the player holds the pair of jacks because it is a winning combination. The player also holds the five of clubs in an attempt to achieve a winning bonus combination.

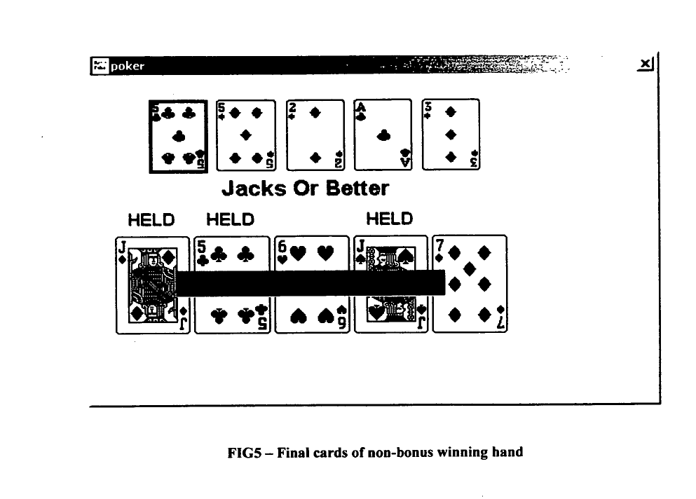

In FIG. 5 the cards are discarded and the new cards are dealt, resulting in the final hand. This hand is evaluated and determined to have a “Jacks or Better” winning combination from the standard poker pay table. Since only one card matches the bonus hand, no bonus award is given. Again, this is particular to the pay table chosen for this example. Other pay tables could allow for one matching card to result in a bonus award.

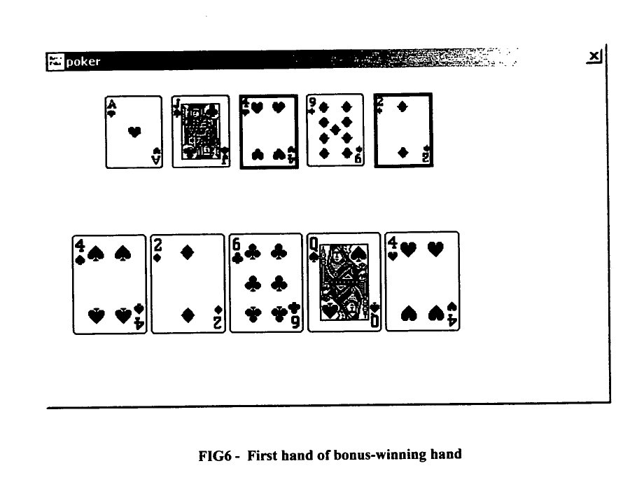

The following example, including FIG. 6 through FIG. 8, depicts the case where the final hand evaluation results in no winning combination from the standard pay table, but does result in a bonus award.

FIG. 6 shows the initial hand and bonus hand. At this point the player decides which, if any, cards to hold and which cards to discard.

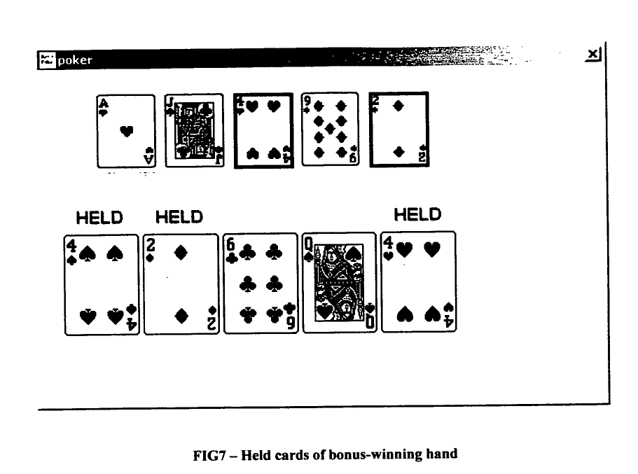

The player holds the four of hearts and the two of diamonds in FIG. 7 because this is a winning bonus combination. Two of the cards in the player's hand match cards in the bonus hand. The player also holds the four of spades in attempt to achieve a winning combination from the standard poker pay table.

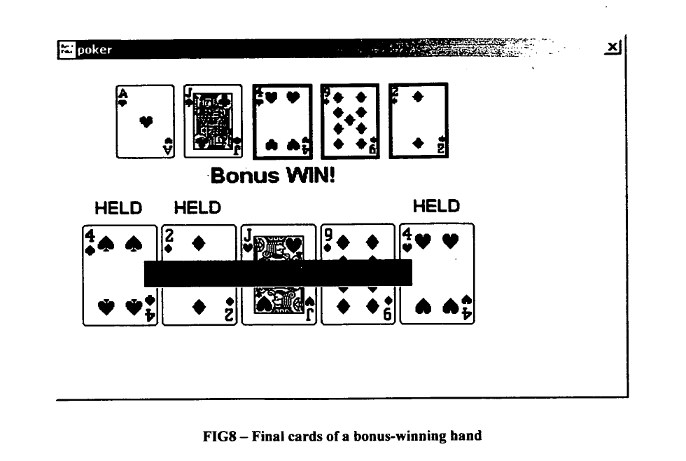

In FIG. 8, the replacement cards are dealt and the final hand is evaluated. There is no winning combination from the standard poker pay table. However, in addition to the two cards that matched the bonus hand from the player's initial hand, one of the replacement cards, the nine of diamonds, also matches the bonus hand, resulting in three cards in the player's final hand matching cards in the bonus hand. This results in a winning combination from the bonus pay table.

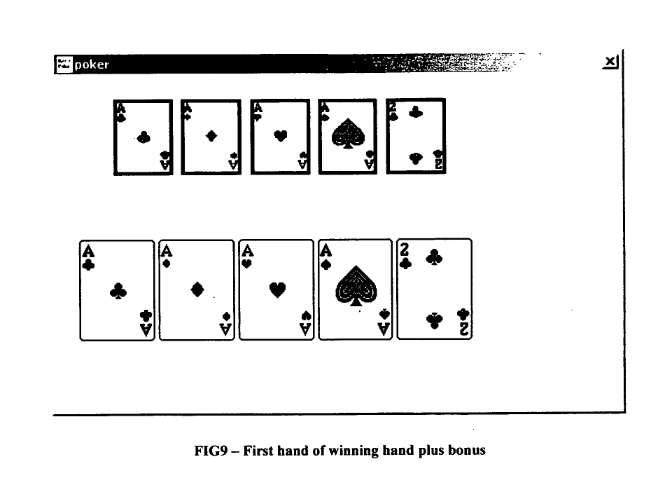

The following example, including FIG. 9 through FIG. 11, depicts the case where the final hand evaluation results in a winning combination from the standard pay table and a bonus award.

FIG. 9 shows the initial hand and bonus hand. At this point the player decides which, if any, cards to hold and which cards to discard.

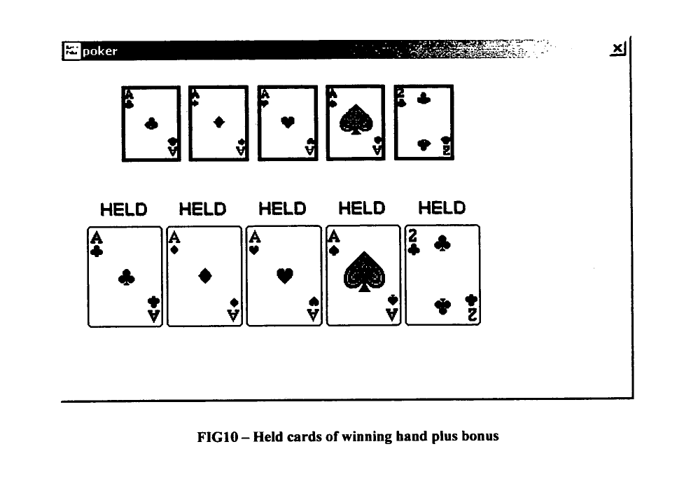

In FIG. 10, the player holds all five cards. All five cards in the player's hand match the bonus cards. In addition, the player's hand also has “Four of a Kind”, a winning combination from the standard poker pay table.

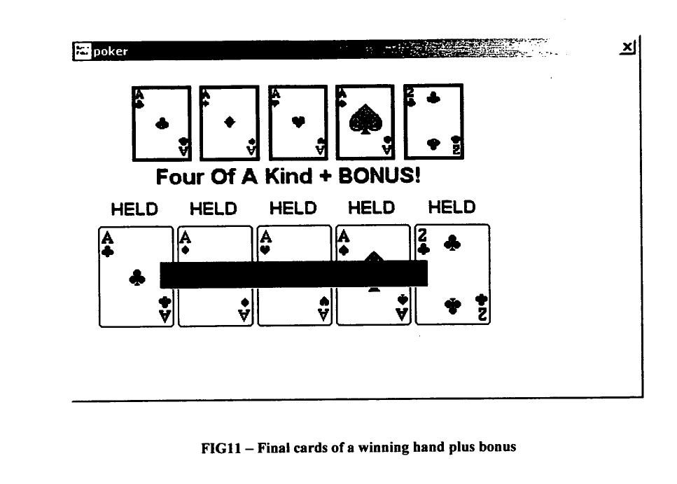

In FIG. 11, since all five cards from the initial hand were held, no replacement cards are dealt, and the final hand is evaluated. All five of the player's final cards match the bonus cards, resulting in a bonus award. Additionally, the player's final hand is a winning combination from the standard poker pay table.

In Version #2, the bonus cycle is used. At the beginning of a bonus cycle, five cards are selected as the bonus hand. To join the bonus cycle, a player makes a wager. Upon dealing the initial hand to the player, the pre-selected bonus hand is also displayed to the player. All players making a wager during a bonus cycle will receive the same bonus hand. Players compete against each other in an attempt to be the first to match all five cards in the bonus hand with cards from their final poker hands. This may span many standard poker hands. Cards from any of a player's final hands that match those in the bonus hand become “qualified”. The final hand is also evaluated in the same manner as Version #1, except that a percentage (from 0 to 100) of the bonus award is paid into a bank. All participating players contribute to this bank. The first player to “qualify” all five bonus cards is awarded the contents of the bank. This ends the bonus cycle.

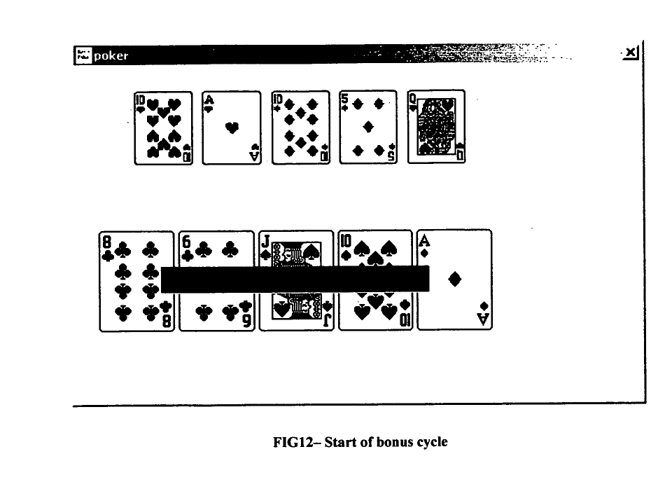

The following example, using FIG. 12 through FIG. 17, shows one player's display throughout a complete bonus cycle. This player qualifies all five bonus cards and is awarded the contents of the bank.

FIG. 12 shows the players display just before the bonus cycle is begun. The player would make a wager to start the game.

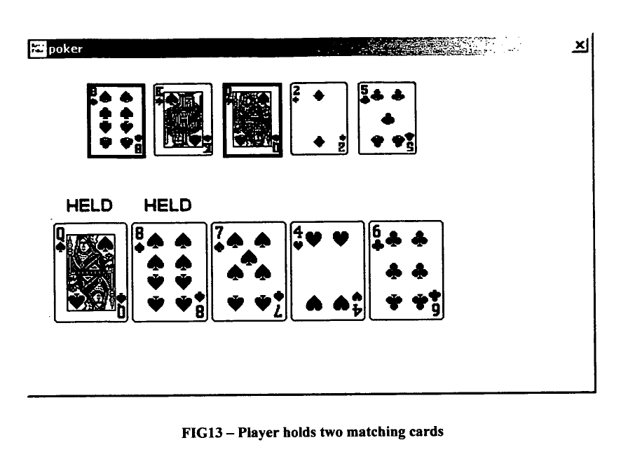

Once the player has wagered, the initial poker hand and the pre-selected bonus hand are displayed as shown in FIG. 13. The player holds the queen and eight of spades since these two cards match cards in the bonus hand.

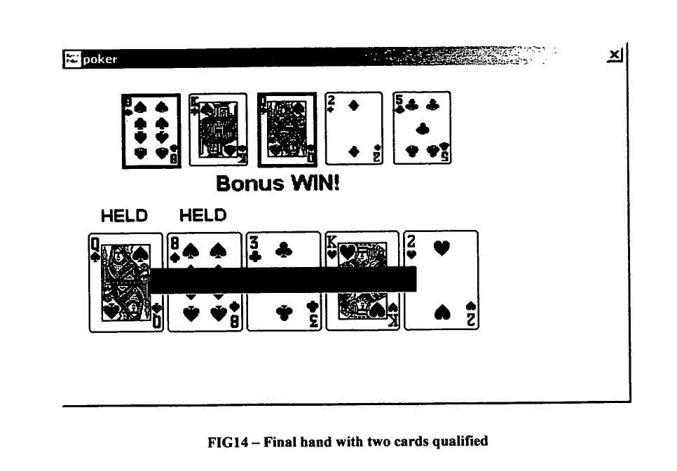

In FIG. 14 the player discards the unwanted cards, and is dealt replacement cards. The final hand is evaluated. There is no winning combination from the standard poker pay table. Two cards matched the bonus hand, which is a winning combination from the bonus pay table. A percentage of this award is paid to the player, and the remainder is paid to the bank.

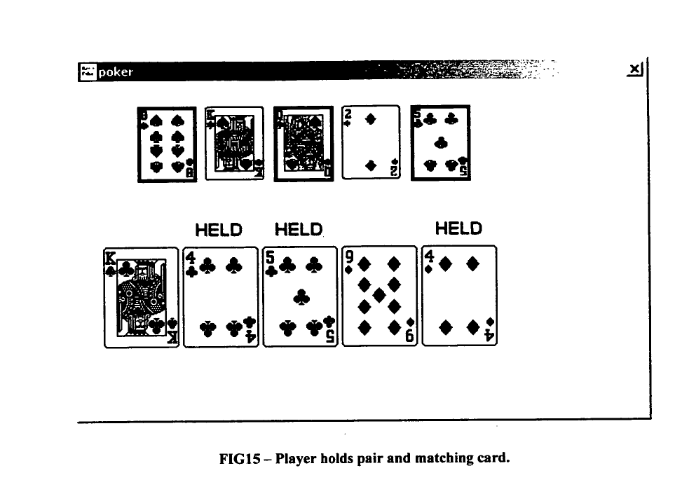

In FIG. 15 the player makes another wager to start a new game. Again, an initial hand is dealt, and the same pre-selected bonus hand is displayed, indicating which cards are already qualified. The five of clubs is indicated as a matching bonus item in addition to the pre-qualified items. The player decides which cards to hold. In this case, a pair of fours is held in an attempt to achieve a winning combination from the standard pay table. Additionally, the five of clubs is held because it matches a card in the bonus hand and has not already been qualified.

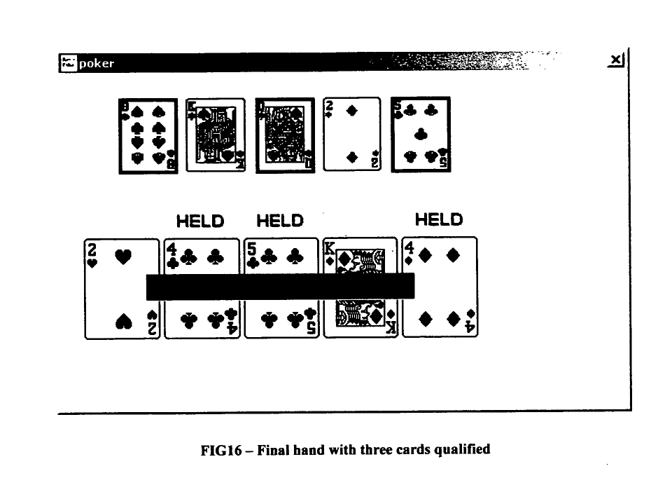

In FIG. 16 the player discards and receives the replacement cards and the final hand is evaluated. There is no winning combination from the standard poker pay table, and since the bonus pay table used requires at least two cards in the final hand to match the bonus cards, no bonus is awarded. It is important to note that only the current final hand is used for bonus evaluation when compared against the bonus pay table. A third card, the five of clubs was qualified. The player now only needs to qualify the king of spades and the two of diamonds to receive the bonus award from the bank.

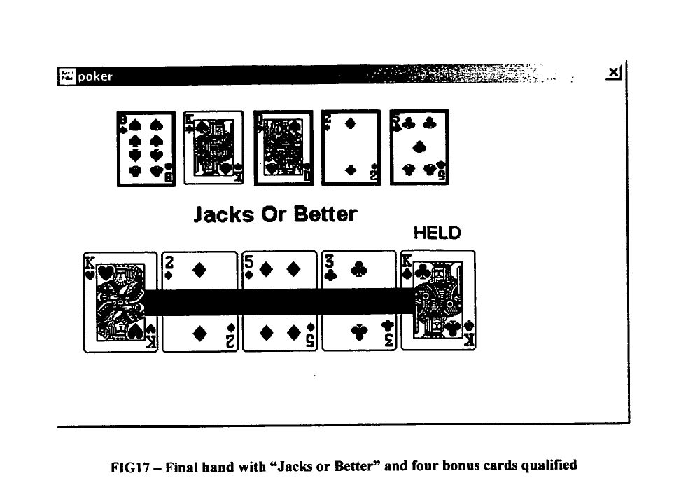

The player makes another wager to start a new game. Again, an initial hand is dealt, and the same pre-selected bonus hand is displayed, indicating which cards are already qualified. The player decides which cards to hold. In this case, the player held the king of clubs in an attempt to achieve a winning combination from the standard poker pay table. Replacement cards were dealt and the final hand as shown in FIG. 17 was evaluated. One of the replacement cards, the two of diamonds, matched one of the bonus cards. The resulting hand had a “Jacks or Better” winning combination from the winning pay table. Only one card in the final hand matched a card in the bonus hand. This is not a win from the bonus pay table used for this example. However, an additional card was qualified. Now, there is only one card remaining to be qualified.

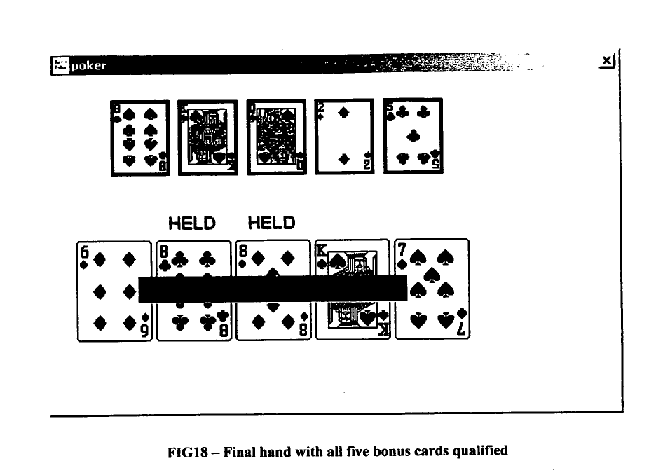

The player makes another wager to start a new game. Again, an initial hand is dealt, and the same pre-selected bonus hand is displayed, indicating which cards are already qualified. The player decides which cards to hold. In this case, the player held the pair of eights. Replacement cards were dealt and the final hand as shown in FIG. 18 was evaluated. There is no win from the standard poker pay table or the bonus pay table, however the remaining bonus item was qualified. This results in the contents of the bank being awarded to the player and concludes the current bonus cycle.

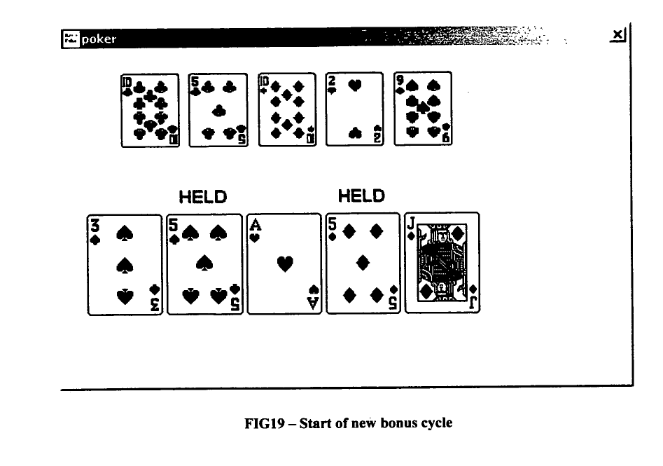

In FIG. 19, the player makes another wager to start a new game. Again, an initial hand is dealt. Since the player just completed the previous bonus cycle, a new bonus cycle begins, and a new bonus hand is displayed.

What is claimed is:

1. A method of playing a video poker game including the following:
a) providing a pay schedule to a player used to award winnings;
b) allowing the player to make a wager to participate in the play of the game;
c) displaying an initial hand of random cards to a player;
d) allowing the player to discard any unwanted cards, if any, and dealing replacement cards for the discarded cards so that a final hand is established;
e) determining whether the final hand is a winning or losing hand;
f) paying the player a pre-established amount based on the amount of the wager and the pay schedule if the final hand is a winning hand.

2. The method of claim 1 including the steps of:
a) providing a bonus pay schedule to the player used to award bonus winnings.
b) displaying random bonus items to the player when the initial hand is displayed;
c) comparing the final hand to the bonus items and determining if any bonus is awarded.
d) paying the player a pre-established amount based on the amount of the wager and the bonus pay schedule.

3. A method of defining a bonus cycle including the steps of:
a) defining the start of a bonus cycle when the first wager is made and no bonus cycle is currently active.
b) selecting a set of random bonus items at the beginning of the bonus cycle;
c) displaying these bonus items to all players participating in the bonus cycle;
d) determining if any player has satisfied the conditions to end the bonus cycle.
e) if conditions have been met, ending the bonus cycle.

4. The methods of claim 1 and claim 3 including the steps of:
a) providing a bonus pay schedule used to award bonus winnings to each player.
b) providing a bank to which bonus winnings are paid and from which bonus winnings are awarded.
c) displaying the bonus items for the current bonus cycle to each player when each player's initial hand is displayed;
d) comparing each player's final hand to the bonus items and determining if any bonus is awarded.
e) comparing the final hand of each player to the bonus items and qualifying the bonus items for each player that match cards in that player's final hand.
f) paying the player a percentage of the pre-established amount based on the amount of the wager and the bonus pay schedule.
g) paying the bank the remaining amount of the award from claim 4f.
h) determining if any player has qualified all bonus items, paying a bonus from the bank, and ending the bonus cycle.

5. The method of claim 2 in which the bonus items are represented as a secondary hand of cards.

6. The method of claim 2 in which the bonus items are represented as five numbered items. The set of numbers from which the value of the bonus items are assigned is also used to assign a unique numerical value to each card.

7. The method of claim 4 in which the bonus items are represented as a secondary hand of cards.

8. The method of claim 4 in which the bonus items are represented as five numbered items. The set of numbers from which the value of the bonus items are assigned is also used to assign a unique numerical value to each card.
